(19) United States
(12) Patent Application Publication
(10) Pub. No.: US 2002/0046978 A1
(43) Pub. Date: Apr. 25, 2002

(54) Condiment bottle cap and method of making same

(76) Inventor: Richard W. Watson, Lakeside, CA (US)

Correspondence Address: Charles W. Forlidas, Miller & Martin LLP, 1000 Volunteer Building, 832 Georgia Avenue, Chattanooga, TN, 37402-2289, US

(21) Appl. No.: 09/999,696

(22) Filed: Oct. 24, 2001

Related U.S. Application Data
(60) Provisional application No. 60/243,238, filed on Oct. 25, 2000.

(51) Int. Cl. B01D 17/025

(52) U.S. Cl. 210/800; 210/801

(57) ABSTRACT

A cap for sealing containers which is designed not to dispense the a runny, less dense phase of an blended or mixed substance that separates upon standing. The cap comprises an upright exit tube extending internal to the cap and forming a retaining pan to catch the quick moving less dense phase and allow the more dense phase to pass through the exit tube first.

### RELATED APPLICATION

This application claims priority to provisional application Ser. No. 60/243,238 filed Oct. 25, 2000.

### BACKGROUND OF THE INVENTION

1. Field of the Invention

This invention relates to a novel cap used for containers, and more particularly, to a cap that traps the top runny or watery phase of a substance so that it does not exit the container as the substance is being dispensed.

2. Description of the Prior Art

Blended or mixed substances, particularly fluids, separate when they have been kept in a container for a period of time without being shaken or stirred. This separation results in two or more phases of the substance which separate according to their density so that the lower density phases accumulate at the top of the container, thereby exiting the container first when the substance is dispensed.

For example, before catsup, mustard or other condiment containers reach a retail location where they will be sold, they often sit in manufacturing facilities and distribution centers undisturbed for long periods of time. Because of their long shelf lives, these goods also often sit undisturbed on store shelves for long periods of time. As is commonly known and experienced by the average consumer, condiments are substances that are prone to separation. As a result, when these blended or mixed substances ultimately reach the consumer where they are to be dispensed from a container through its cap, they have separated forming two or more phases of different densities. The separation of the blended or mixed liquids results in the less desirable, lighter, runny or watery portion of the substance settling towards the top of the container as a top phase (or phases) and the heavier, more desirable portion of the substance settling towards the bottom of the container as a bottom phase. As a result of this separation, the less dense top phase, consisting primarily of the runny or watery portion of the substance, is first to exit the container before the more dense substance is dispensed.

Consumers do not like the runny or watery top phase for a variety of reasons. For example, with regard to condiments, the runny or watery top phase of the substance makes the bread or buns of a sandwich damp and soggy. The separation of many common food substances also occurs naturally, such as in many pureed food products, including catsup, applesauce and mustard.

Some attempts to address the problem of dispensing liquids of different densities are illustrated in U.S. Pat. No. 4,934,420 to Radna and U.S. Pat. Nos. 5,804,082 and 5,993,676 to Lowery, Jr. Each of these patents use complicated containers or adapters for separating and selectively dispensing liquids. In practice, however, devices like those described in U.S. Pat. Nos. 4,934,420, 5,804,082 and 5,993,676 have several potential disadvantages. These devices are complicated and expensive to implement on inexpensive containers which are typically discarded after they have been consumed. For example, it is not economically feasible to use these devices in the production of inexpensive condiment containers.

Other attempts to separate and pour separable or immiscible substances include U.S. Pat. No. 1,058,599 to Kiger and U.S. Pat. No. 1,488,865 to Castor. Both of these patents teach a pouring device for separating milk and cream. The pouring devices of these patents are also complicated and expensive to implement on inexpensive containers which are typically discarded after they have been consumed. Moreover, these devices have each encountered continued problems with separation of the milk and cream and are not consistently functional. The functionality of these products requires some manipulation and precise orientation before the desired substance is dispensed. Furthermore, in order to selectively pour specific phases of the substance it is necessary to position the prior art containers in a specific manner. Finally, the prior art pouring devices all involve extending part of the pouring device into the mouth of the container.

None of the aforementioned prior art pouring devices are directed to only dispensing the more dense phase of the substance before the less dense phase.

It would, therefore, be highly desirable to provide a new and improved cap for containers, wherein the cap is capable of preventing the runny or watery phase of an blended or mixed substance from exiting the cap first, and wherein the cap is inexpensive to produce. A desirable cap would not act as a perfect separator for decanting select phases of a substance, rather it would function more as a temporary trap for small, less desirable portions of the substance and allow the more desired portion to be decanted first.

### SUMMARY OF THE INVENTION

Substances such as catsup, mustard, and other condiments settle and separate into a runny or watery top portion and a heavier bottom portion when sitting in a container for long periods of time. Often, even after vigorous shaking, a small amount of the runny substance or phase of the liquid is first to exit the container. As used in this disclosure, the term “phase” is used to refer to both discrete homogeneous portions of the separable substance and to refer to non-homogeneous portions or solutions that simply comprise varying concentrations of some or all of the elements of the substance. This invention solves the problem of blended or mixed substances which separate in containers, accumulating in the top phase of the container, causing the runny or watery phase of the substance to exit the cap first.

The cap of the present invention traps the low density, top phase of the substance in the container so that it is not dispensed. This result is achieved by the use of an improved cap which contains a hollow extended interior exit tube connected to and extending from the aperture of the cap. As a container is tilted, overturned or even completely inverted to dispense its contents, the less dense, watery or runny phase of the substance moves toward the cap more quickly than the more viscous denser substance and is trapped in the retaining pan formed between the exit tube and the wall of the cap. The preferable denser substance comprising the blended phase reaches the interior end of the tube and passes through to the aperture of the cap. Accordingly, this design traps the quickly moving watery substance in the retaining pan and allows the more desired substance to exit the cap first.

### BRIEF DESCRIPTION OF THE DRAWINGS

FIG. 1 is a front perspective view of one embodiment of the cap of the present invention.

FIG. 2 is a cross sectional view of a preferred embodiment of the cap of the present invention.

FIG. 3 shows a front perspective view of yet another embodiment of the cap of the present invention.

### DETAILED DESCRIPTION OF THE INVENTION

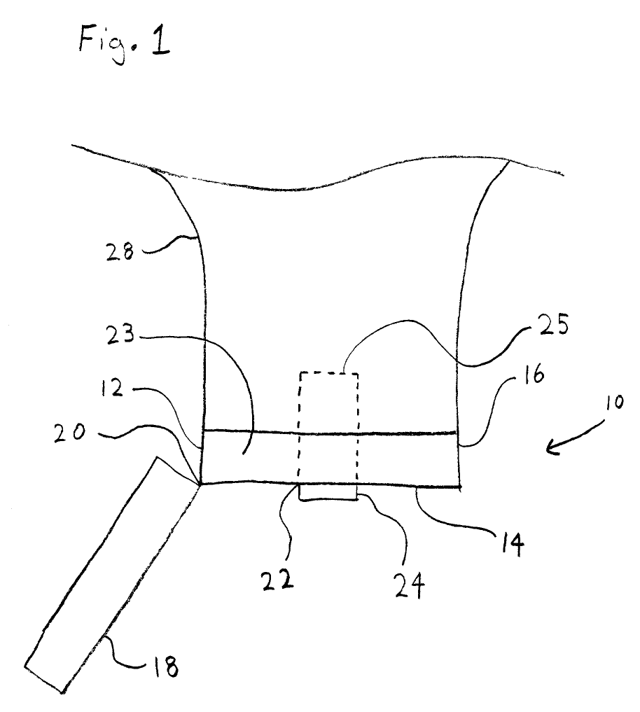

Referring to FIG. 1, the cap 10 of the present invention preferably includes a body 12 comprising a cap base 14 having interior and exterior surfaces, a surrounding outer wall 16 having inner and outer surfaces extending from the cap base 14 and running about the periphery of the base 14, and means for attaching the cap 10 to the neck or mouth of a container 28, such as a retaining or coupling member 17 of wall 16. The cap 10 further comprises a hollow exit tube 24 connected to and extending into the cap 10 from an aperture 22 in the cap base 14. The aperture 22 is preferably centrally located on the cap base 14. A hinge 20 connects the lid 18 to the body of the cap 12.

The cap 10 is essentially a hollow body, formed of relatively thin walls that define an interior space, cavity region or retaining pan 23 within which to trap the watery substance, said retaining pan 23 bounded by the inner or interior surface of the wall 16, interior surface of the base 14 and the outer or exterior surface of the exit tube 24. The cap 10 can be made of any suitable material known in the art, such as plastic or metal.

The extended interior exit tube 24 is a generally vertically upstanding hollow tube that is preferably positioned to run through the center of the cap base 14 so that it extends from the interior surface of the cap base 14 into the container 28 and to the exterior surface of the cap base 14, defining an aperture 22 though which the substance may exit the container. It is not necessary that the exit tube 24 extend past or outside of the exterior surface of the cap base 14, however, as shown in FIG. 1, a short extension that may be covered by the cap 10 is preferable to avoids messiness and a build up of the dispensed substance on the exterior surface of the cap base 14 and also aids the user in directing the dispensing of the substance. The exit tube 24 must, however, extend past or beyond the interior surface of the cap base 14 so that it forms a retaining pan 23 in which the watery or runny phase of the substance is collected when the container is slanted or inverted.

To obtain a retaining pan 23 having maximum volume for any given length of exit tube 24, the axis of the exit tube 24 is preferably oriented at substantially right angles (perpendicularly) to the plane of the cap base 14 or aperture 22. The wall of the exit tube 24 may also extend into the container 28 at right angles from the cap base 14, however, alternatively, the exit tube 24 may be wider at the open interior end 25 than at the aperture 22 to facilitate the entry of the denser phase of the substance being decanted. In another alternative embodiment, the wall of the exit tube 24 may be narrower at the open interior end 25 than at the aperture 22. Walls having such a slant will assist gravity in breaking any suction or vacuum between parallel walls of the retaining pan 23 and pulling the less dense phase of the substance from the retaining pan 23 when the container 28 is returned to the upright position after being tilted or inverted to dispense the more dense phase.

The length of the interior extension of the exit tube 24 maybe adjusted based on the volume of the container, larger volume containers requiring a deeper retaining pan 23 to accommodate the proportionally larger volume of the watery phase of the substance until the undiluted substance reaches the open interior end 25 of the exit tube 24 and passes through the aperture 22 to the outside of the cap 10. The length of the interior extension of the exit tube 24 may also be adjusted based on the characteristics and qualities of the substance being dispensed, some substances typically having a greater proportion of watery phase than other substances. Finally, the width of the exit tube 24 may also be adjusted as desired to accommodate the viscosity of the more dense phase of the substance.

This design traps the quickly moving watery phase of the substance in the retaining pan 23 formed between the exit tube 24 and the interior of the body wall 16 and allows the substance to exit the container before the less dense phase. Because the runny or watery top phase of the substance is typically less dense than the bottom phase of the substance, when the container is tilted or turned upside down to dispense the substance, the watery or runny portion runs toward the cap 10 first and is often the first to be dispensed in prior condiment caps. The present invention, however, “traps” the watery or runny phase of the substance in the retaining pan 23 of the cap 10. The interior exit tube 24 extends into the cap 10 and/or container 28 past the expected typical depth of the collected watery portion of the substance. Thus, when the more desirable bottom phase of the substance reaches the open interior end 25 of the hollow exit tube 24, it will pass through the exit tube 24 and aperture 22 while the watery portion remains trapped below the level of the open interior end 25 of the tube 24.

The cap 10 is connected to the mouth of a container 28 by means of the coupling member 17 typically located on the inner or outer wall 16. The coupling member 17 provides an attachment area as a means for attaching the cap 10 to the mouth of the container 28. The coupling member 17 may comprise any attachment means known in the art, such as screw top threads which mate with corresponding threads on the container 28. Alternately, the coupling member 17 may comprise a retaining bead (not shown) to serve as an attachment means, said retaining bead being angular and pointing radially inwards, and running around the inside of the interior wall 16 of the body 12. On its surface lying at the radially innermost point, the retaining bead possesses a retaining area, said retaining area engaging with corresponding retaining elements positioned about the container wall. Other coupling member 17 attachment means are also within the contemplation of the present invention.

The cap 10 has a hinge 20 that is preferably connected to the lid 18 and the cap base 14 or wall 16, allowing the lid 18 to open and close with ease so that the lid 18 covers the body 12 of the cap 10 of the container when it is not being used. The hinge 20 can be formed as a slight weakening of the material in the wall 16. In order to open the lid 18, a pull off ring (not shown) can be provided on the lid 18, said ring being connected to the outer surface the wall of the lid 18 at least on one connecting point. Alternately, a depression can also be formed on the outer surface of the wall 16 of the cap base 14 in order to allow the lid 18 to be pushed up and easily opened.

In sum, FIG. 1 is a front perspective view of one embodiment of the cap 10, illustrated with its lid 18 the open position, the cap 10 being attached to a typical container 28, such as a bottle of catsup. The body 12 of the cap 10 is formed by a circular disc-shaped cap base 14, a cylindrical wall 16 abutting to the edge of the cap base 14, an extended interior exit tube 24, and an aperture 22. The exit tube 24 of this embodiment extends through the interior surface of the cap base 14 into the container and through the exterior surface of the cap base 14 and defines an aperture 22 though which the substance may exit the container.

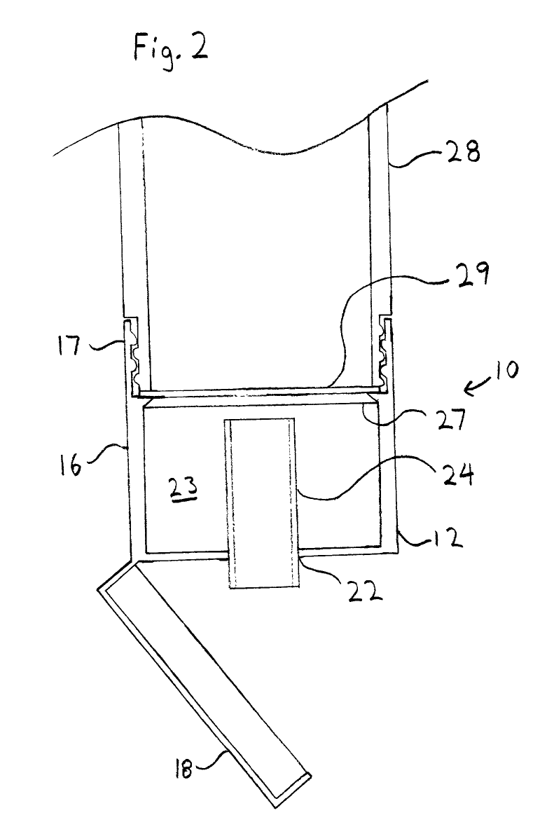

FIG. 2 shows a cross sectional view of a preferred embodiment of the cap 10 of the present invention, also illustrated with the lid 18 in a partially open position. This embodiment illustrates an embodiment of a cap 10 formed for use in connection with a container 28 having a seal, such as foil seal 29, across the mouth of the container 28. The use of such seals 29 is common in the industry for safely packaging food products. As illustrated in FIG. 1, the exit tube 24 extends through the mouth of the container 28 beyond where a seal 29 might be used, making that embodiment incompatible with containers sealed prior to their first use by the consumer. The embodiment of FIG. 2 can be attached to the container 28 at an end opposite the aperture 22 by the coupling member 17 (here illustrated as a typical screw-on cap) without violating or compromising the seal 29. This may be accomplished by a number of methods such as by varying the length of the exit tube 24 so that it does not extend from the cap base 14 beyond the wall 16 of the body 12 of the cap 10. Alternatively, the wall 16 can be lengthened or extended to allow for a lengthy exit tube 24 that does not extend through the mouth of the container 28. Lengthening the wall 16 and the exit tube 24 is effective to enlarge the volume of the retaining pan 23. Alternatively, the exit tube 24 can be said to extend beyond the body of the cap but not past the point where the coupling member 17 attaches to the mouth of the container 28, nor the point where a seal may cover the mouth of the container 28.

The wall 16 of the cap 10 maybe provided with a gasket member such as gasket or lip 27 to form a seal with the mouth of the container 28 when the cap 10 is in place. Alternatively, instead of a gasket or lip 27 similar to that illustrated in FIG. 2, the wall 16 could simply be thickened to provide the requisite seal. Likewise, the gasket member may comprise a separate inner wall (not shown) extending from the base 14 to pliably intersect with the mouth of the container 28.

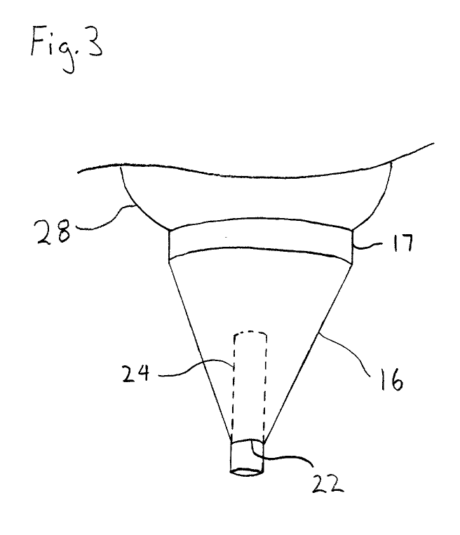

FIG. 3 shows a front perspective view of yet another embodiment of the cap 10 of the present invention. In this embodiment, the cap 10 is substantially conically shaped like the top of a typical mustard bottle 28. The cap 10 has angular walls 16 extending inward from the coupling member 17 to intersect directly with the aperture 22 of the exit tube 24 thereby obviating the need for a cap base 14. The familiar screw opening outer cover portion of a typical mustard bottle is not shown in FIG. 3 so that important aspects of the present invention may be clearly illustrated. In this, as with all embodiments, it is preferable that the vertical axis of the exit tube 24 extend substantially parallel to the vertical axis of the container 28 to lessen the likelihood of any of the less dense phase of the substance entering the open end 25 of the exit tube 24 when the container 28 is initially turned over or tilted to decant the substance before the desired more dense phase of the substance. It has been found that orienting the exit tube 24 parallel to the upright or vertical axis of the container 28 achieves maximum efficiency of the retaining pan to fill with the less dense phase of the substance regardless of the original orientation of the container 28.

The cap 10 of the present invention may be used in connection with any substance that has a tendency to separate into a lighter, less dense, less desirable portion that it may be preferable to avoid dispensing, and a heavier, more dense desirable portion. Such substances may include, but are not limited to food products, condiments, cosmetic products, pharmaceutical and chemical products and any other substance known in the art.

While several embodiments of the present invention have been disclosed, it is to be understood by those skilled in the art that other forms can be adopted, all coming within the spirit of the invention and scope of the appended claims.

I claim:

1. A cap for dispensing a more dense phase of a substance having at least two phases of different densities from a container, comprising:
(a) a hollow body having an interior surface and an exterior surface and having an aperture through the hollow body, the interior surface of the hollow body defining an interior space;
(b) a hollow exit tube having an interior surface and an exterior surface, the exit tube extending from the aperture into the interior space of the hollow body; and
(c) said exit tube defining a cavity between the exterior surface of the exit tube and the interior surface of the hollow body.

2. The cap according to claim 1 wherein the exit tube extends outside of the exterior surface of the hollow body.

3. The cap according to claim 1 wherein the exit tube extends at a substantially right angle to the plane of the aperture.

4. The cap according to claim 1 wherein the hollow body comprises a base and a surrounding wall extending from the base, the hollow exit tube extending from the base within the interior surface of the hollow body.

5. The cap according to claim 4 wherein the exit tube extends at a substantially right angle to the base.

6. The cap according to claim 4 wherein the exit tube does not extend beyond the hollow body past the height of the surrounding wall.

7. The cap according to claim 1 wherein the hollow body further comprises an attachment means for attaching the cap to the container.

8. The cap according to claim 1 wherein the hollow body further comprises a coupling member for attaching the cap to the container.

9. The cap according to claim 1 wherein the exit tube does not extend within the container to which the cap is attached.

10. The cap according to claim 1 wherein the cap is attached to the container having a mouth capable of being sealed with a seal, and wherein the exit tube does not compromise the seal.

11. The cap according to claim 1 wherein the container is capable of being sealed with a seal when the cap is attached to the container.

12. The cap according to claim 1 further comprising a lid connected to the hollow body.

13. The cap according to claim 1 further comprising a gasket member to provide a seal with a container to which the cap is attached.

14. A method of dispensing a more dense phase of a substance having at least two phases of different densities from a container, the method comprising the steps of:
(a) utilizing a cap with the container, the cap comprising:
(i) a hollow body having an interior surface and an exterior surface and having an aperture through the body, the interior surface of the hollow body defining an interior space;
(ii) a hollow exit tube having an interior surface and an exterior surface, the exit tube extending from the aperture into the interior space of the hollow body; and
(iii) said exit tube defining a cavity between the exterior surface of the exit tube and the interior surface of the hollow body; and
(b) overturning the container thereby causing a less dense phase of the substance to flow into the cavity and allowing a more dense phase to enter the exit tube prior to the less dense phase.

15. The method according to claim 14 wherein the exit tube extends outside of the exterior surface of the hollow body.

16. The method according to claim 14 wherein the hollow body comprises a base and a surrounding wall extending from the base, the hollow exit tube extending from the base within the interior surface of the hollow body.

17. The method according to claim 16 wherein the exit tube does not extend beyond the hollow body past the height of the surrounding wall.

18. The method according to claim 14 wherein the hollow body comprises an attachment means for attaching the cap to the container.

19. The method according to claim 14 wherein the hollow body further comprises a coupling lit member for attaching the cap to the container.

20. The method according to claim 14 wherein the exit tube does not extend within the container to which the cap is attached.

21. The method according to claim 14 wherein the cap is attached to the container having a mouth capable of being sealed with a seal, and wherein the exit tube does not compromise the seal.

22. The cap according to claim 14 wherein the container is capable of being sealed with a seal when the cap is attached to the container.

23. The method according to claim 14 further comprising a lid connected to the hollow body.

24. The method according to claim 15 further comprising a gasket member to provide a seal with a container to which the cap is attached.

25. A cap for a container comprising:
(a) a body defining an aperture at a first end;
(b) an exit tube extending from the aperture internal to the body, said body and tube defining a retaining pan; and
(c) a coupling member at a second end of the body for attaching the cap to the container.

26. The cap according to claim 25 wherein the exit tube extends at a substantially right angle to the plane of the aperture.

27. The cap according to claim 25 further wherein said body further comprises a base about the aperture and a surrounding wall about the base.

28. The cap according to claim 27 wherein the exit tube extends at a substantially right angle to the base.

29. The cap according to claim 27 wherein the exit tube does not extend beyond the body past the height of the surrounding wall.

30. The cap according to claim 25 wherein the exit tube does not extend within the container to which the cap is attached.

31. The cap according to claim 25 wherein the cap is attached to the container having a mouth capable of being sealed with a seal, and wherein the exit tube does not compromise the seal.

32. The cap according to claim 25 wherein the container is capable of being sealed with a seal when the cap is attached to the container.

33. The cap according to claim 25 further comprising a lid connected to the first end of the body.

34. The cap according to claim 25 further comprising a gasket member to provide a seal with the container to which the cap is attached.

35. A cap for a container comprising:
(a) a base defining an aperture;
(b) a surrounding wall about the base;
(c) an exit tube extending from the aperture internal to the surrounding wall at a substantially right angle to the base; and
(d) a coupling member on the surrounding wall for attaching the cap to the container.

36. The cap according to claim 35 wherein the exit tube does not extend past the height of the surrounding wall.

37. The cap according to claim 35 wherein the exit tube does not extend within the container to which the cap is attached.

38. The cap according to claim 35 wherein the cap is attached to the container having a mouth capable of being sealed with a seal, and wherein the exit tube does not compromise the seal.

39. The cap according to claim 35 wherein the container is capable of being sealed with a seal when the cap is attached to the container.

40. The cap according to claim 35 further comprising an attached lid to cover the base.

41. The cap according to claim 35 further comprising a gasket member to provide a seal with the container to which the cap is attached.

42. The cap according to claim 35 wherein the aperture is centrally located on the base.

43. A cap for a container comprising:
(a) a base defining an aperture;
(b) a surrounding wall about the base;
(c) an exit tube extending from the aperture internal to the surrounding wall, said exit tube not extending past the height of the surrounding wall; and
(d) a coupling member on the surrounding wall for attaching the cap to the container.

44. The cap according to claim 43 wherein the exit tube extends from the aperture internal to the surrounding wall at a substantially right angle to the base.

45. The cap according to claim 43 wherein the exit tube does not extend within the container to which the cap is attached.

46. The cap according to claim 43 wherein the cap is attached to the container having a mouth capable of being sealed with a seal, and wherein the exit tube does not compromise the seal.

47. The cap according to claim 43 wherein the container is capable of being sealed with a seal when the cap is attached to the container.

48. The cap according to claim 43 further comprising an attached lid to cover the base.

49. The cap according to claim 43 further comprising a gasket member to provide a seal with the container to which the cap is attached.

50. The cap according to claim 43 wherein the aperture is centrally located on the base.

51. A cap for a container comprising:
(a) a base defining an aperture;
(b) a surrounding wall about the base;
(c) an exit tube extending from the aperture internal to the surrounding wall at a substantially right angle to the base, said exit tube not extending past the height of the surrounding wall; and
(d) a coupling member on the surrounding wall for attaching the cap to the container.

52. The cap according to claim 51 wherein the exit tube does not extend within the container to which the cap is attached.

53. The cap according to claim 51 wherein the cap is attached to the container having a mouth capable of being sealed with a seal, and wherein the exit tube does not compromise the seal.

54. The cap according to claim 51 wherein the container is capable of being sealed with a seal when the cap is attached to the container.

55. The cap according to claim 51 further comprising an attached lid to cover the base.

56. The cap according to claim 51 further comprising a gasket member to provide a seal with the container to which the cap is attached.

57. The cap according to claim 51 wherein the aperture is centrally located on the base.

58. A condiment bottle cap comprising:
(a) an body defining a retaining pan to trap a less dense phase of the condiment;
(b) an exit tube through the retaining pan defining an aperture through which the more dense phase of the condiment may pass.

59. The cap according to claim 58 wherein the exit tube extends at a substantially right angle to the plane of the aperture.

60. The cap according to claim 58 further comprising a coupling member for attaching the body of the cap to the container.

61. The cap according to claim 58 further wherein said body further comprises a base about the aperture and a surrounding wall about the base.

62. The cap according to claim 61 wherein the exit tube extends at a substantially right angle to the base.

63. The cap according to claim 61 wherein the exit tube does not extend past the height of the surrounding wall.

64. The cap according to claim 58 wherein the cap is attached to the container having a mouth capable of being sealed with a seal, and wherein the exit tube does not compromise the seal.

65. The cap according to claim 58 wherein the container is capable of being sealed with a seal when the cap is attached to the container.

66. The cap according to claim 58 wherein the exit tube does not extend within the container to which the cap is attached.

67. The cap according to claim 58 further comprising a lid.

68. The cap according to claim 58 further comprising a gasket member to provide a seal with the container to which the cap is attached.

69. A cap for a container comprising:
(a) a base defining an aperture;
(b) a surrounding wall about the base;
(c) an exit tube extending from the aperture internal to the surrounding wall;
(d) a coupling member on the surrounding wall for attaching the cap to the container;
(e) said container having a mouth capable of being sealed with a seal; and
(f) wherein the exit tube does not compromise the seal when the cap is attached to the container.

70. The cap according to claim 69 wherein the exit tube extends at a substantially right angle to the plane of the aperture.

71. The cap according to claim 69 wherein the exit tube extends at a substantially right angle to the base.

72. The cap according to claim 69 wherein the exit tube does not extend beyond the body past the height of the surrounding wall.

73. The cap according to claim 69 wherein the exit tube does not extend within the container to which the cap is attached.

74. The cap according to claim 69 wherein the container is capable of being sealed with a seal when the cap is attached to the container.

75. The cap according to claim 69 further comprising a lid connected to the surrounding wall.

76. The cap according to claim 69 further comprising a gasket member to provide a seal with the container to which the cap is attached.

77. A cap for a container comprising:
(a) a base defining an aperture;
(b) a surrounding wall about the base;
(c) an exit tube extending from the aperture internal to the surrounding wall; and
(d) a coupling member on the surrounding wall for attaching the cap to the container, and
(e) wherein the container is capable of being sealed with a seal when the cap is attached to the container.

78. The cap according to claim 77 wherein the exit tube extends at a substantially right angle to the plane of the aperture.

79. The cap according to claim 77 wherein the exit tube extends at a substantially right angle to the base.

80. The cap according to claim 77 wherein the exit tube does not extend beyond the body past the height of the surrounding wall.

81. The cap according to claim 77 wherein the exit tube does not extend within the container to which the cap is attached.

82. The cap according to claim 77 wherein the cap is attached to the container having a mouth capable of being sealed with a seal, and wherein the exit tube does not compromise the seal.

83. The cap according to claim 77 further comprising a lid connected to the surrounding wall.

84. The cap according to claim 77 further comprising a gasket member to provide a seal with the container to which the cap is attached.
